(19) United States
(12) Patent Application Publication
(10) Pub. No.: US 2021/0016802 A1
(43) Pub. Date: Jan. 21, 2021

(54) METHOD AND DEVICE FOR OPERATING AN AUTOMATED VEHICLE

(71) Applicant: Robert Bosch GmbH, Stuttgart (DE)

(72) Inventors: Erik Herzhauser, Bad Rappenau - Heinsheim (DE); Jochen Schaeferling, Bietigheim-Bissingen (DE); Kai Layer, Weinstadt (DE)

(21) Appl. No.: 16/925,616

(22) Filed: Jul. 10, 2020

(30) Foreign Application Priority Data
Jul. 17, 2019 (DE) 102019210568.8

(51) Int. Cl. B60W 60/00; B60W 40/08; G06K 9/00

(52) U.S. Cl. CPC B60W 60/0025; B60W 40/08; B60W 2540/043; G06K 9/00832; G06K 9/00288

(57) ABSTRACT

Method and device for operating an automated vehicle that has an occupant compartment, including a step of receiving predefined occupant data, which represent a predefined number of occupants and/or predefined occupant features, a step of detecting actual occupant data based on the occupants actually present in the occupant compartment, and a step of operating the automated vehicle as a function of the predefined occupant data and as a function of the actual occupant data.

### CROSS REFERENCE

The present application claims the benefit under 35 U.S.C. § 119 of German Patent Application No. DE 102019210568.8 filed on Jul. 17, 2019, which is expressly incorporated herein by reference in its entirety.

### SUMMARY

The present invention relates, among other things, to a method for operating an automated vehicle including a step of receiving predefined occupant data, a step of detecting actual occupant data and a step of operating the automated vehicle as a function of the predefined occupant data and as a function of the actual occupant data.

The method according to an example embodiment of the present invention for operating an automated vehicle that has an occupant compartment, includes a step of receiving predefined occupant data, which represent a predefined number of occupants and/or predefined occupant features, a step of detecting actual occupant data based on the occupants actually present in the occupant compartment, and a step of operating the automated vehicle as a function of the predefined occupant data and as a function of the actual occupant data.

An automated vehicle is to be understood to mean a vehicle that is designed according to one of the SAE Levels 1 to 5 (see SAE J3016 Standard). An automated vehicle that has an occupant compartment is in particular to be understood to mean an automated bus or a so-called automated shuttle. In this case, the automated vehicle has an occupant compartment, i.e., a compartment designed to transport occupants. Depending on the design of the occupant compartment, the transport may take place in a seated and/or standing and/or lying position, for example. In one possible specific embodiment, the automated vehicle additionally has a compartment, which is included in the occupant compartment or is separated from the occupant compartment, for storing or transporting cargo (luggage, etc.).

Predefined occupant data, which represent a predefined number of occupants and/or predefined occupant features, are, for example, understood to mean a (digital) list of occupants that includes a number of occupants for a certain tour of the automated vehicle. In one specific embodiment, the predefined occupant data additionally or alternatively include predefined occupant features that include a detailed list of the occupants, for example a list of names. In one possible specific embodiment, the predefined occupant data include a list of names and/or pictures and/or IDs of all occupants, for example, who are scheduled for a certain tour of the automated vehicle. In a further possible specific embodiment, the predefined occupant features include certain types of clothing and/or a certain color of clothing. In this case, the automated vehicle is, for example, designed as a shuttle in a connected area, this shuttle being provided for transporting a certain occupation group, identifiable in this case due to the certain type of clothing and/or due to the certain color of clothing. In a further specific embodiment, the occupant data additionally or alternatively include further occupant-specific features, such as a movement pattern and/or an eye color and/or a size and/or a hair color, etc.

Actual occupant data, based on the occupants actually present in the occupant compartment, are for example to be understood to mean sensor data that represent the occupants actually present in the occupant compartment of the vehicle. These sensor data are detected, for example, with the aid of a surroundings sensor system situated in the occupant compartment of the automated vehicle. A surroundings sensor system is, for example, to be understood to mean at least one video and/or at least one radar and/or at least one LIDAR and/or at least one ultrasonic and/or at least one thermal and/or at least one further sensor (iris scanner, etc.) that is/are designed to detect the occupant compartment of the automated vehicle, in particular in the form of actual occupant data. In one specific embodiment, the surroundings sensor system additionally includes evaluation means (processor, random access memory, hard drive, software), for example, that are designed to evaluate the occupant data and to thus detect and/or determine a number of occupants and/or occupant features (face, clothes, position in the occupant compartment, etc.), for example.

Occupants are understood to mean at least one person and/or at least one animal.

The example method according to the present invention may advantageously achieve the object of providing a method to be carried out by an automated vehicle, the operation of this automated vehicle in particular depending on the occupants who use the automated vehicle. Among other things, this poses a problem in particular, since in an automated vehicle, nobody normally assumes control as to whether actually all occupants or whether actually the correct occupants, which are scheduled for a tour, are already present in the automated vehicle. This object is achieved or this problem is solved with the aid of the example method according to the present invention in that the automated vehicle is operated as a function of predefined occupant data, which represent a predefined number of occupants and/or predefined occupant features, and as a function of the actual occupant data based on the occupants actually present in the occupant compartment.

The predefined occupant data are preferably received from an external server.

An external server is, for example, understood to mean an individual server and/or a combination of servers (cloud) that is designed to exchange data values, in particular predefined occupant data, with the automated vehicle via a radio communication and/or a cable connection, for example. In one specific embodiment, the external server is additionally or alternatively designed as a control unit of a control center for the automated vehicle, for example, that automatedly transmits travel routes in the form of trajectories to be traveled by the automated vehicle, to the automated vehicle and/or due to an input by an operator of the control center.

The operation of the automated vehicle preferably includes traveling along a trajectory, the traveling not starting until the actual occupant data corresponds to the predefined occupant data according to predefined criteria. In a further specific embodiment, the traveling does not start, for example, until all occupants have additionally or alternatively assumed their predefined positions (for example a seat or a certain standing area having holding devices, etc.) and/or have put their seatbelts on, for example. This may be monitored, for example, with the aid of the surroundings sensor system and/or appropriate sensors in the particular buckle device.

An operation of the automated vehicle is—depending on the SAE Level in which the vehicle is operated—additionally or alternatively for example understood to mean determining a trajectory for the automated vehicle and/or traveling the trajectory with the aid of an automated transversal and/or longitudinal control(s) and/or carrying out safety-relevant driving functions, such as outputting a warning signal (for example to an occupant of the automated vehicle), for example.

The operation preferably includes outputting a signal in the occupant compartment, the signal in particular representing an occupant status.

Outputting a signal is, for example, understood to mean a visual and/or an acoustic and/or a haptic signal. In one specific embodiment, the signal is a visual signal, for example, that is output or displayed on a monitor in the occupant compartment in the form of an image or a text. An occupant status is, for example, understood to mean whether the occupants are complete or not (yet) complete as a function of the predefined occupant data and as a function of the actual occupant data. In one specific embodiment, the occupant status, for example, additionally includes—as a function of the predefined occupant data and as a function of the actual occupant data—a time indication of the potential departure and/or arrival times of the automated vehicle and/or a travel route, for example in the form of stops, at which the automated vehicle will stop.

Detecting actual occupant data preferably includes facial recognition of the actually present occupants and/or an input signal of at least one authenticated occupant.

Facial recognition is, for example, understood to mean the detection of one or multiple faces (of the occupants in the present case) that are detected and determined with the aid of a video sensor and a corresponding evaluation unit. The video sensor is, for example, understood to mean a sensor of the surroundings sensor system, as described above.

An input signal of at least one authenticated occupant is, for example, to be understood to mean a signal that is input with the aid of an input device (keyboard, reading unit for reading in an authorization, for example with the aid of an authorization card, finger print scanner, lock for a corresponding key, facial recognition, etc.). For example, the at least one authenticated occupant is to be understood to mean the only person who is authorized to start the travel of the automated vehicle from a certain location. This person verifies this authorization with the automated vehicle with the aid of the input signal.

An example device according to the present invention, in particular a control unit, is configured to carry out all steps of the example method(s) described herein for operating an automated vehicle.

For example, the device is designed as a control unit of the automated vehicle and includes a processing unit (processor, random access memory, hard drive) as well as a suitable software, in order to carry out the example method(s) described herein. In one specific embodiment of the present invention, the device includes a transceiver unit that is designed to exchange data values, in particular with an external server or a cloud and/or an infrastructure device. In a further specific embodiment, the device additionally or alternatively includes a data interface, for example, to exchange data values with a transceiver unit of the automated vehicle. The device further includes a data interface, for example, for requesting and/or receiving an input signal.

A computer program is furthermore provided, including commands that prompt the computer to carry out a method described herein for operating an automated vehicle, when the computer program is carried out by a computer. In one specific embodiment of the present invention, the computer program corresponds to the software encompassed by the device.

Furthermore, a machine-readable memory medium is provided, on which the computer program is stored.

Advantageous refinements of the present invention described herein.

### BRIEF DESCRIPTION OF THE DRAWINGS

Exemplary embodiments of the present invention are illustrated in the FIGURE and explained in greater detail in the description below.

FIG. 1 shows, in the form of a flow chart, one exemplary embodiment of a method according to the present invention.

### DETAILED DESCRIPTION OF EXAMPLE EMBODIMENTS

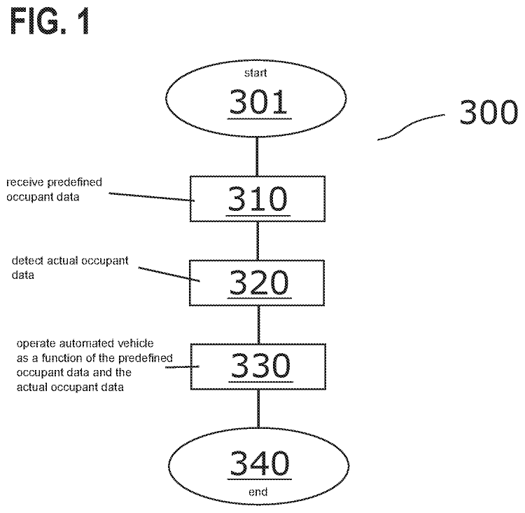

FIG. 1 shows one exemplary embodiment of a method 300 for operating an automated vehicle that has an occupant compartment.

Method 300 starts in step 301.

In step 310, predefined occupant data are received, which represent a predefined number of occupants and/or predefined occupant features.

In step 320, actual occupant data are detected based on the occupants actually present in the occupant compartment.

In step 330, the automated vehicle is operated as a function of the predefined occupant data and as a function of the actual occupant data.

In one specific embodiment, the automated vehicle is for example operated as a function of the predefined occupant data and as a function of the actual occupant data in such a way that the automated vehicle does not start a tour until the number of the predefined occupants, represented by the predefined occupant data, corresponds to the number of the actually present occupants, represented by the actual occupant data. In one specific embodiment, the predefined occupant data correspond for example to a maximally admissible number of occupants in the occupant compartment of the automated vehicle and the actual occupant data correspond to a number of occupants actually present in this occupant compartment. In this case, the automated vehicle is for example operated in such a way that a tour only starts if the actual number does not exceed the maximally admissible number. For this purpose, a corresponding signal is output, for example, such as a prompt directed toward the occupants to leave the automated vehicle at least in part.

Method 300 ends in step 340.

What is claimed is:

1. A method for operating an automated vehicle that has an occupant compartment, comprising the following steps:
receiving predefined occupant data, which represent a predefined number of occupants and/or predefined occupant features;
detecting actual occupant data based on occupants actually present in the occupant compartment; and
operating the automated vehicle as a function of the predefined occupant data and as a function of the actual occupant data.

2. The method as recited in claim 1, wherein the predefined occupant data are received from an external server.

3. The method as recited in claim 1, wherein the operating of the automated vehicle includes traveling by the automated vehicle along a trajectory, the traveling not starting until the actual occupant data corresponds to the predefined occupant data according to predefined criteria.

4. The method as recited in claim 1, wherein the operating of the automated vehicle includes outputting a signal in the occupant compartment, the signal representing an occupant status.

5. The method as recited in claim 1, wherein the detecting of the actual occupant data includes facial recognition of the actually present occupants and/or an input signal of at least one authenticated occupant.

6. A control unit configured to operate an automated vehicle that has an occupant compartment, the control unit configured to:
receive predefined occupant data, which represent a predefined number of occupants and/or predefined occupant features;
detect actual occupant data based on occupants actually present in the occupant compartment; and
operate the automated vehicle as a function of the predefined occupant data and as a function of the actual occupant data.

7. A non-transitory machine-readable memory medium on which is stored a computer program for operating an automated vehicle that has an occupant compartment, the computer program, when executed by a computer, causing the computer to perform the following steps:
receiving predefined occupant data, which represent a predefined number of occupants and/or predefined occupant features;
detecting actual occupant data based on occupants actually present in the occupant compartment; and
operating the automated vehicle as a function of the predefined occupant data and as a function of the actual occupant data.
